(19) United States
(12) Patent Application Publication
(10) Pub. No.: US 2022/0210984 A1
(43) Pub. Date: Jul. 7, 2022

(54) TREE CULTIVATION DEVICE

(71) Applicant: Chad Sutherland, Bradenton, FL (US)

(72) Inventor: Chad Sutherland, Bradenton, FL (US)

(21) Appl. No.: 17/568,941

(22) Filed: Jan. 5, 2022

Related U.S. Application Data
(60) Provisional application No. 63/134,642, filed on Jan. 7, 2021.

(51) Int. Cl. A01G 13/02; A01G 25/00

(52) U.S. Cl. CPC A01G 13/0237; A01G 25/00

(57) ABSTRACT

A tree cultivation device having a hollow frustoconical body configured for receiving and enclosing a tree base therein. The frustoconical body including (i) a base of the device configured for positioning on a ground or potting surface adjacent to a tree base, (ii) a top end configured to receive a portion of a tree trunk therethrough; (iii) a plurality of troughs formed within an outer surface of the hollow frustoconical body that are positioned between the base and top end of the device; and (iv) an open and closable slit that continuously extends on the hollow frustoconical body from the top end of the device to the base so that a tree base may be received internally within the hollow frustoconical body of the device.

### TECHNICAL FIELD

The present invention relates generally to the field of cultivation devices, and more particularly, to tree cultivation devices configured for water conservation, irrigation purposes, and protection of the tree base and bark around the tree base.

### BACKGROUND

When cultivating trees, such as various different species of fruit trees (e.g., citrus, apple, cherry, etc.), many different tree cultivation devices are known such as those disclosed in U.S. Pat. No. 8,296,995 “Tree Protection and Water Saving Apparatus” and U.S. Pat. No. 9,814,188 “Tree Trunk Housing and Adjustable Water-Saving Device”. However, these devices are often difficult to assemble, disassemble, and/or difficult to use. For example, many devices require complex assembly of several individual components via fasteners, which is both time consuming and cumbersome. These fasteners must be periodically replaced to ensure proper functionality of these devices. Moreover, certain devices lack sufficient rigidity to properly protect the portion of the tree housed therein and/or to properly pass and/or conserve water from an exterior of the above mentioned devices into an interior of the device. Thus, in view of these disadvantageous and unfavorable features, a need for additional tree cultivation devices exists.

### SUMMARY

It is an object of the invention to provide a tree cultivation device that properly houses a portion of a tree therein and that has sufficient rigidity to protect that portion of the tree while housed within the device from inclement weather conditions, falling/flying debris during such inclement weather conditions, and/or insects by enclosing the tree base therein when the device is in use. Moreover, this device includes unique features such as troughs and openings configured to capture and pass externally originating liquids (e.g., rainwater) into the interior of the device that aid in achieving the objective of minimizing and/or reducing the need for constant irrigation of these trees while concurrently providing the above mentioned protection characteristics. These devices further advantageously include anchoring means that stabilize and anchor the device in a desired location such that inclement weather conditions will not displace and/or remove the device from its desired location while in use. Specifically disclosed is a tree cultivation device for water conservation and/or protection comprising: (a) a hollow frustoconical body configured for receiving and enclosing a tree base therein; the hollow frustoconical body comprising: (i) a base of the device configured for positioning on a ground or potting surface around and adjacent to (laterally adjacent to circumferentially surround) a tree base in which a tree is planted, the base comprising an anchoring means attached to the base of the device that is configured to anchor the device into the ground or potting surface while the tree base is received or enclosed in the device; (ii) a top end of the device with an opening defined by peripheral edges formed in the top end, the opening configured to receive a portion of a tree trunk therethrough and the peripheral edges defining the opening that are configured to directly contact and support the tree trunk; (iii) a plurality of troughs formed within an outer surface of the hollow frustoconical body that are positioned between the base and top end of the device, each trough is spaced apart from one another and each trough is configured to dispense a liquid from an outer surface of the device internally within the device; and (iv) a slit that continuously extends on the hollow frustoconical body from the peripheral edges defining the top end of the device to the base, such that the slit is openable (arrow O¹) and closable (arrow C¹) such that a tree base may be received (and enclosed) internally within the hollow frustoconical body when the device is in use. In certain aspects, above mentioned features (i)-(iii) of the frustoconical body are unitary and/or monobloc. In certain aspects, above mentioned features (i)-(iv) of the frustoconical body are unitary and/or monobloc. In each of these aspects, the device is injection molded from, for example, moldable and/or thermoplastic resin including but not limited to a polyolefin, a polyurethane, or a polystyrene.

In certain aspects, the device comprises a concentric ring configuration when viewed from a top and/or bottom view.

In certain aspects, the device comprises a stepped configuration when viewed from a side view.

In certain aspects, the top end of the device comprises a planar surface radially extending inwardly from an outermost edge of the top end towards a center of the top end in which the peripheral edges of the opening are positioned.

In certain aspects, the top end further comprises a predetermined shape immediately adjacent to the peripheral edges of the opening on the top end and extending in a direction away from the planar surface of the top end, the predetermined shape and peripheral edges are resiliently deformable to receive and support the tree trunk therein when the device is in use. The predetermined shape is preferably a triangular shape when viewed from a top and/or bottom view.

In certain aspects, the base is annular and/or circular shaped.

In certain aspects, the anchoring means are directly attached to the base and are configured to anchor the device within the ground or potting surface, preferably immediately adjacent to a tree base. In certain aspects, the anchoring means are removably attachable and detachable from the base; the anchoring means can be attached to the base via a number of fastening means such as a threaded engagement, a snap fit engagement, a friction fit engagement, or any combination thereof.

In certain aspects, the anchoring means includes a plurality of projections directly connected to and circumferentially positioned around the base with each projection extending in a direction away from the top end and base of the device.

In certain aspects, each projection of the plurality of projections of the anchoring means terminates in a sharp (and/or pointed) end configured to penetrate the ground or potting surface around and adjacent to the tree base to anchor the device when the device is in use.

In certain aspects, each trough has a curved shape configured to capture liquid emitted from an external source (e.g., rainwater or an external irrigation source) and pass the captured liquid to an interior of the device.

In certain aspects, the curved shape is a concavity extending in a direction from an outer surface towards the interior of the device when viewed from a top view of the device.

In certain aspects, each trough has an opening positioned therein that is in fluid communication with the interior of the device such that liquid captured from an exterior of the device on the trough is passed into the interior of the device via the opening positioned in each trough. In certain aspects and to further facilitate liquid drainage from the trough into the interior of the device via each opening, portions of the trough immediately adjacent to each opening are angled towards (e.g., decline angle towards) each opening to further facilitate drainage of the liquid from the trough through the opening into the interior of the device.

In certain aspects, the opening in each trough has a parallel axial alignment (axis parallel with V¹) relative to the opening in the top end of the device.

In certain aspects, each trough is a circular shape formed on an outer diameter of the device when viewed from a top view of the device.

In certain aspects, each trough has a plurality of openings positioned therein with each opening of the plurality of openings in fluid communication with the interior of the device such that liquid captured in each trough is passed from the exterior of the device on the trough to the interior of the device via each opening positioned in each trough.

In certain aspects, each opening of the plurality of openings in each trough has a parallel axial alignment (axis parallel with V¹) relative to the opening in the top end.

In certain aspects, the device comprises a first and second trough with the first trough being more proximate to the top end of the device than the second trough, and the second trough being more proximate to the base of the device than the first trough.

In certain aspects, an outer diameter (OD²) of the second trough is greater than an outer diameter (OD¹) of the first trough.

In certain aspects, also disclosed is a kit having the tree cultivation device packaged therein.

Embodiments of the invention can include one or more or any combination of the above features and configurations.

Additional features, aspects and advantages of the invention will be set forth in the detailed description, which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 is a top perspective view of the tree cultivation device;

FIG. 2 is a bottom perspective view of the tree cultivation device;

FIG. 3 is a bottom view of the tree cultivation device;

FIG. 4 is a top view of the tree cultivation device;

FIG. 5 is a front view of the tree cultivation device;

FIG. 6 is a back view of the tree cultivation device;

FIG. 7 is a left side view of the tree cultivation device;

FIG. 8 is a right side view of the tree cultivation device; and

FIG. 9 depicts the device base anchored slightly beneath (D¹—depth beneath) an uppermost surface of the ground or potting surface to minimize loss (water escaping underneath the device) and reduce/prevents invasive insect intrusion and damage to the tree base while the device is in use.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

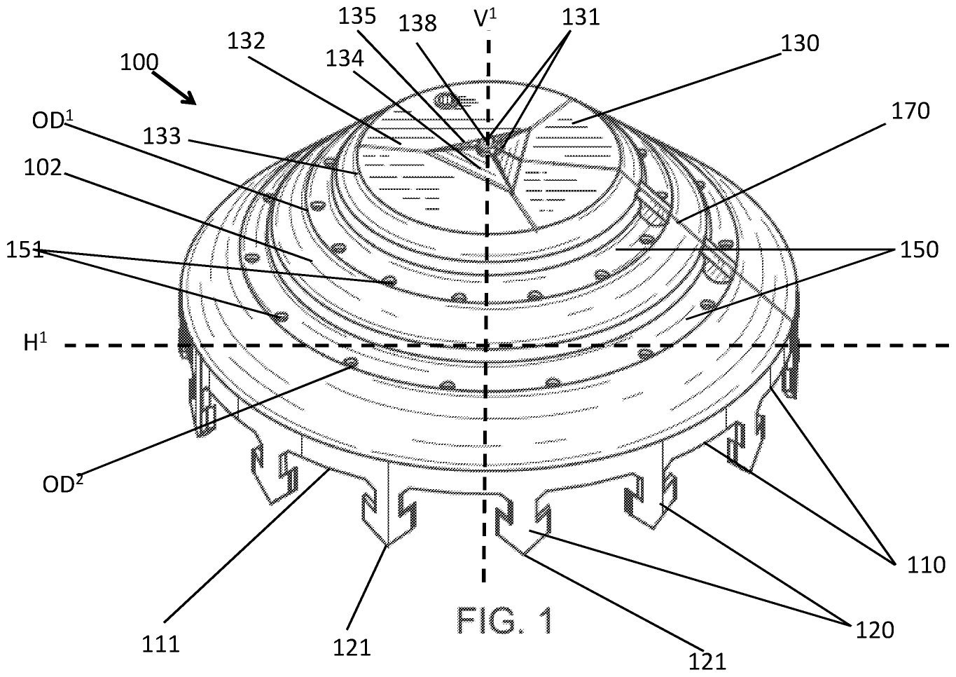

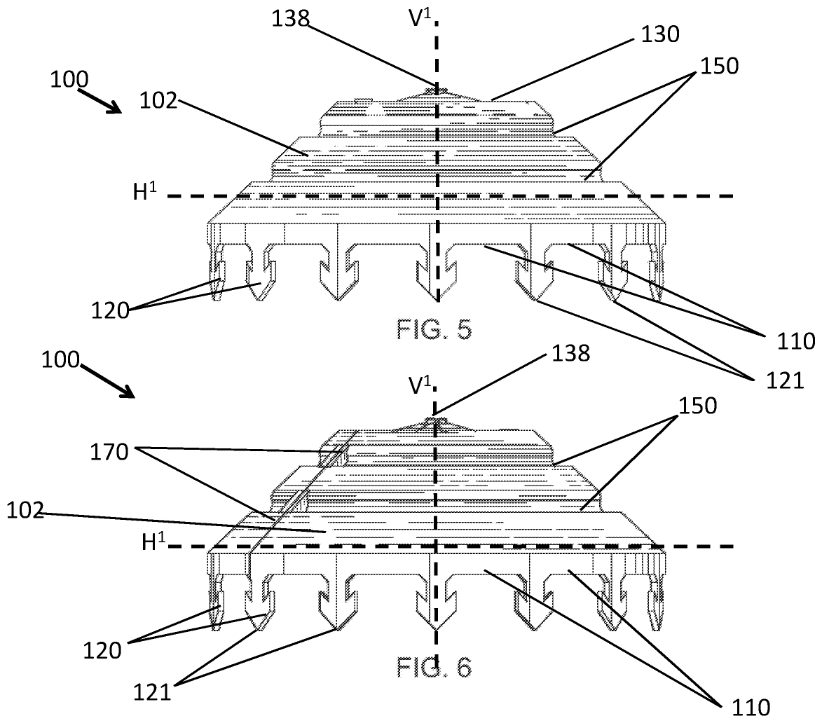

With specific reference to FIGS. 1-9, a tree cultivation device (100) for water irrigation, water conservation, and/or protection is disclosed. This tree device advantageously anchors the device to the ground and/or potting soil via the disclosed anchoring means (120) while in use and concurrently provides sufficient rigidity to protect the portion of the tree housed therein. Moreover, unlike conventional devices, the disclosed device (100) further includes water irrigation and/or conservation features such as top end (130) that forms a substantially enclosed interior of the device once a tree is received within therein as well as troughs (150) and openings (151) configured to capture and pass externally originating liquids (e.g., rainwater and/or external irrigation water source) into the interior of the device to further minimize and/or reduce the need for irrigation of the trees being cultivated.

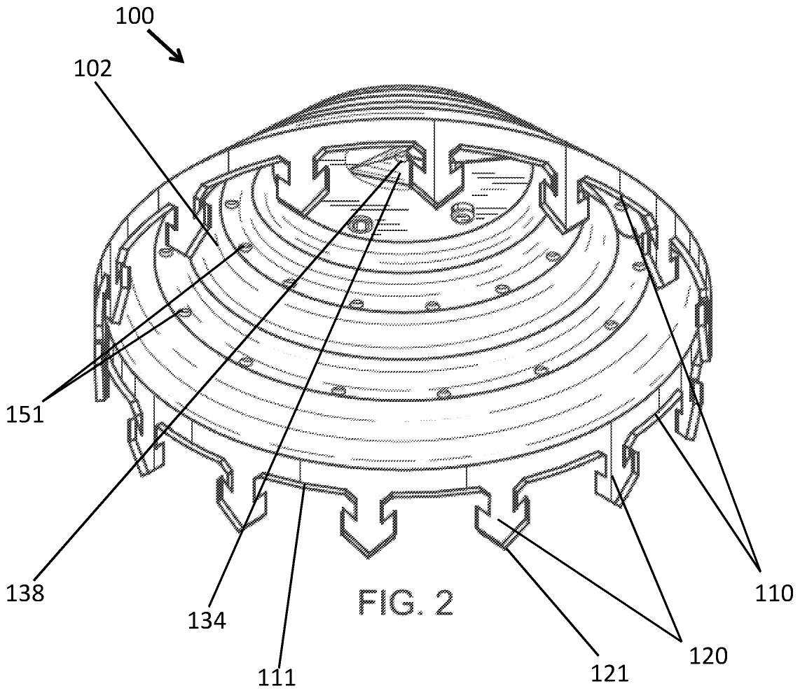

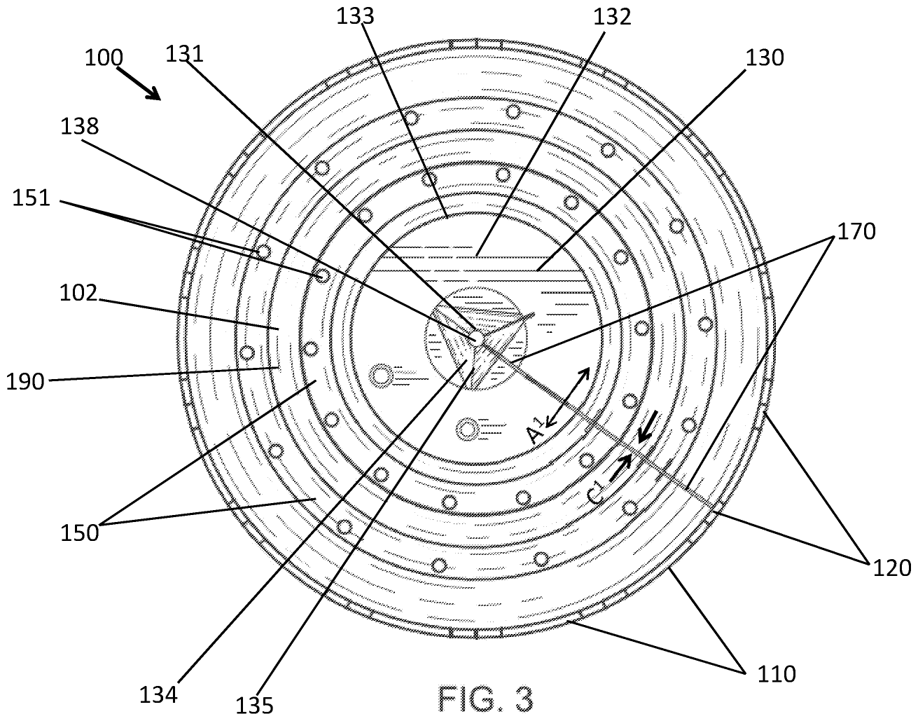

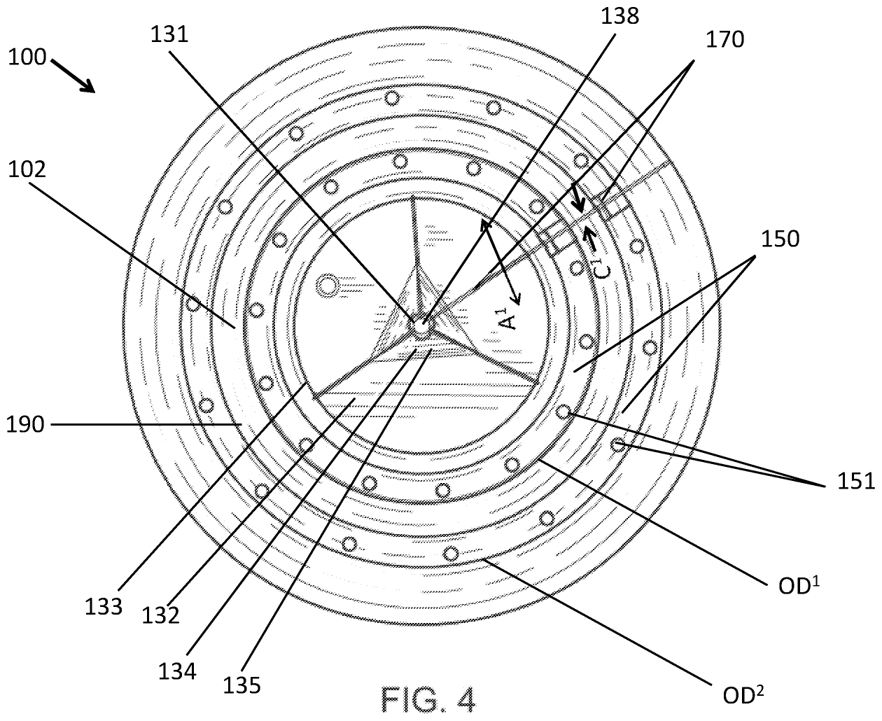

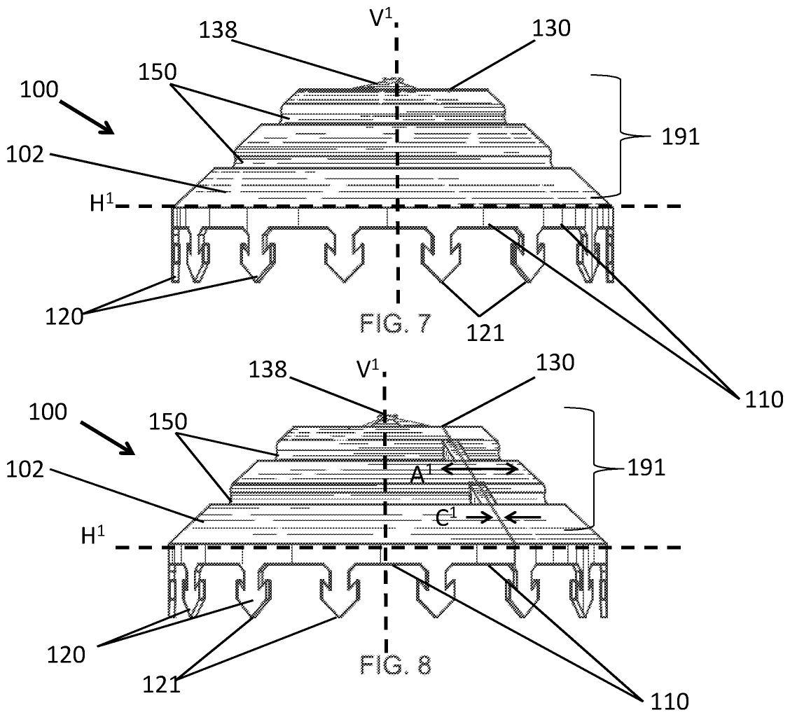

FIGS. 1-9 specifically disclose the tree cultivation device (100) for water irrigation, water conservation, and/or protection that includes a hollow frustoconical body (102) configured for receiving and enclosing a tree base therein. The hollow frustoconical body (102) includes: (i) a base (110) of the device configured for positioning on a ground or potting surface around and adjacent to a tree base in which a tree is planted, the base (110) comprising an anchoring means (120) attached to the base of the device that is configured to anchor the device into the ground or potting surface while the tree base is received or enclosed in the device; (ii) a top end (130) of the device with an opening (138) defined by peripheral edges (131) formed in the top end, the opening configured to receive a portion of a tree trunk therethrough and the peripheral edges defining the opening that are configured to directly contact and support the tree trunk; (iii) a plurality of troughs (150) formed within an outer surface of the hollow frustoconical body that are positioned between the base and top end of the device, each trough is spaced apart from one another and each trough is configured to dispense a liquid from an outer surface of the device internally within the device; and (iv) a slit (170) that continuously extends on the hollow frustoconical body from the peripheral edges defining the top end of the device to the base, such that the slit is openable (arrow O¹) and closable (arrow C¹) such that a tree base may be received internally within the hollow frustoconical body when the device is in use. Opposing sides of the slit (170) may be temporarily fastened to one another while the device is in use and after a tree has been received and enclosed within the device. As further shown, for example in FIGS. 3 and 4, the device includes a concentric ring configuration (190) when viewed from a top and/or bottom view, and as further shown in FIGS. 7 and 8, the device includes a stepped configuration (191) when viewed from a side view. These configurations advantageously allow for sufficient surface area for capturing external liquids/water and for passing liquids/water from an exterior of the device to an interior (shown in FIG. 2) of the device. Moreover, these specific configurations, in particular the arrangement of the top end (130) of the device (disclosed below in further detail), provides support to the base of the tree, which is especially important when cultivating young trees.

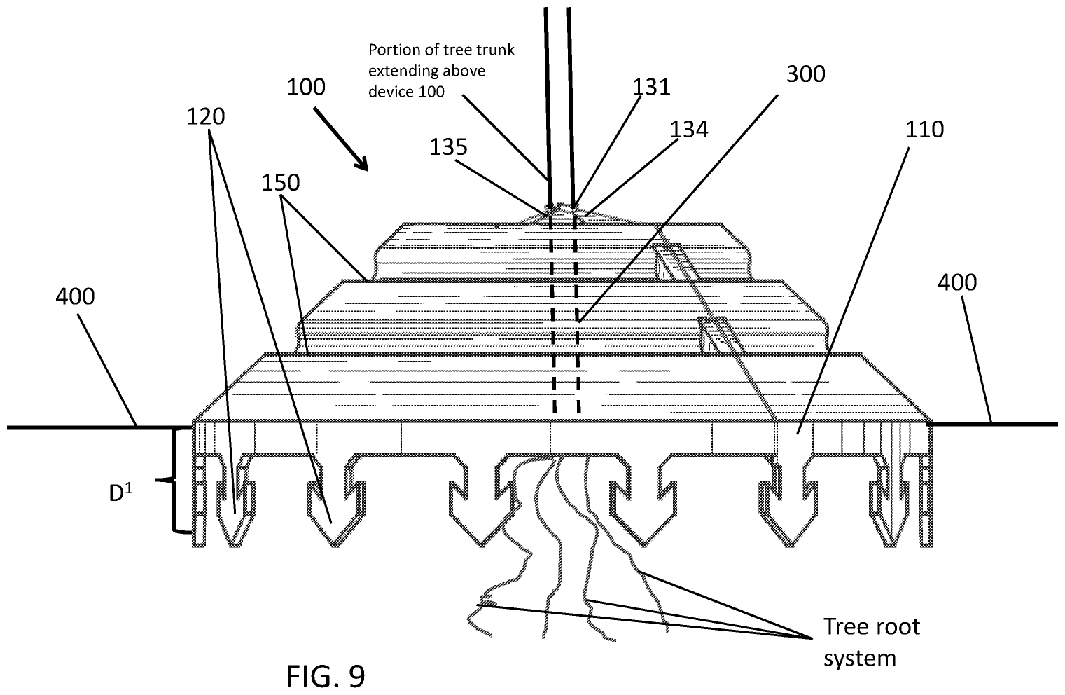

As shown, for example, in FIGS. 1, 3, and 4, the top end (130) of the device (100) includes a planar surface (132) that radially extends inwardly from an outermost edge (133) of the top end towards a center of the top end in which the peripheral edges (131) of the opening (138) are positioned. As further shown in FIGS. 1, 3, and 4, the top end further includes a predetermined shape (134) immediately adjacent to the peripheral edges (131) of the opening (138) the top end that is further configured to optimally provide support to the tree base and trunk. In certain aspects, the predetermined shape extends in a direction away from the planar surface (132) of the top end as well as in a direction away from the base of the device (120) such that the predetermined shape (134), peripheral edges (131) and opening (138) are the uppermost features on the device when the device is oriented in an upright and/or operable position. In certain aspects, the predetermined shape and peripheral edges are resiliently deformable to receive, conform around, directly contact, and support the tree trunk therein when the device is in use. As shown, in FIGS. 1, 3, and 4-8, in certain aspects, the predetermined shape is preferably a triangular shape (135) with the apex of the triangular shape including the peripheral edges (131) formed thereon that define opening (131). As discussed immediately above and when receiving a tree trunk therein while in use, the apex and peripheral edges (131) are resiliently deformable and act in concert to receive the tree trunk in opening (131) and further conform around, directly contact, and support the tree trunk therein when the device is in use, which is further depicted in FIG. 9.

In certain aspects and as shown in FIG. 9, it is particularly advantageous to fix the device into the ground and/or potting soil so that positioning of the device will be unaffected even during inclement weather (high winds, thunderstorms, etc.). In this aspect, the base is annular shaped (111), and preferably includes anchoring means directly attached to the base (110). In certain aspects, the anchoring means are removably attachable and detachable from the base (not shown); the anchoring means can be attached to the base via a number of fastening means such as a threaded engagement, a snap fit engagement, a friction fit engagement, or any combination thereof. As shown in FIGS. 1, 2, and 5-9, the anchoring means (120) includes a plurality of projections directly connected to and circumferentially positioned around the base with each projection extending in a direction away from the top end (130) and base (110) of the device. In certain aspects, each projection (120) of the plurality of projections of the anchoring means terminates in a sharp (and/or pointed) end (121) configured to be driven into and penetrate the ground or potting surface such that the base is positioned around (circumferentially positioned around) and adjacent (laterally adjacent) to the tree base while anchoring the device in a desired location when the device is in use. As shown in FIG. 9, the arrangement of the base (110) and anchoring means (120) advantageously allows the device user to anchor the base (120) of device (100) either substantially flush with and/or slightly beneath (D¹—depth beneath) an uppermost surface (400) of the ground or potting surface by driving the anchoring means into the uppermost surface of the ground or potting surface; this advantageously minimizes water escaping underneath the device (i.e., from the interior to the exterior) while the device is in use, reduces evaporation of water from the interior of the device, and reduces and/or prevents invasive insect intrusion and damage to the tree base (300).

As discussed above, one objective of the disclosed device is to minimize and/or reduce the need for constant irrigation of these trees. The device accomplishes this objective, in part, by capturing and passing externally originating liquids (e.g., rainwater and/or external irrigation water) into the interior of the device. As previously discussed, the device (100) preferably includes a plurality of troughs (each trough 150) formed on an exterior of the device. These troughs are preferably circular shaped (either continuous or discontinuous circles) formed on an outer diameter of the device when the device is viewed from the top. As further shown in FIGS. 1 and 4, each trough has a curved shape configured to capture liquid emitted from an external source and pass the captured liquid to an interior of the device. In certain aspects and as further shown for example in FIGS. 1 and 4, the curved shape is preferably a concavity (or concave shape) extending in a direction (H¹, horizontal axis of device) from an outer surface towards the interior of the device (100) when viewed from a top view of the device. In certain aspects and to further accomplish the objectives mentioned above, each trough includes an opening (151) positioned therein that is in fluid communication with the interior of the device such that liquid captured from an exterior of the device is passed into the interior of the device via the opening positioned in each trough, which is shown in FIGS. 1 and 2. The opening (151) in each trough preferably has a parallel axial alignment (axis parallel with V¹) relative to the opening (138) in the top end (130) so that the opening (151) may pass and/or direct water from the trough directly onto and/or immediately adjacent to the tree base, thereby further enhancing and/or optimizing the irrigation characteristics of the device to the tree/tree base. Moreover and to further facilitate liquid drainage from the trough (150) into the interior of the device via each opening (151), portions of the trough (150) immediately adjacent to each opening (151) are angled towards (e.g., decline/downward angle towards) each opening to further facilitate drainage of the liquid from the trough (150) through the opening (151) into the interior of the device.

With further reference to FIGS. 1-4, each trough (150) preferably includes a plurality of openings (151) positioned therein such that each opening of the plurality of openings is in fluid communication with the interior of the device such that liquid captured in each trough (150) is passed from the exterior of the device to the interior of the device via each opening positioned in each trough. Moreover, each opening (151) of the plurality of openings in each trough has a parallel axial alignment (axis parallel with V¹) relative to the opening (138) in the top end (130) so that the each opening (151) of the plurality of openings may pass and/or direct water from the trough directly onto and/or immediately adjacent to the tree base, thereby further enhancing and/or optimizing the irrigation characteristics of the device to the tree/tree base.

As further shown for example in FIGS. 1, 4, and 5, the device (100) includes a first and second trough with the first trough being more proximate to the top end (130) of the device than the second trough, and the second trough being more proximate to the base (120) of the device than the first trough. As further shown in FIGS. 1, 4, and 5, an outer diameter (OD²) of the second trough is greater than an outer diameter (OD¹) of the first trough. Although the figures depict the presence of two troughs (150) within the device, the number of troughs may be varied, and it is envisioned that the number of troughs included in the device (100) may range from 1 to 6 troughs depending on the height and width of the device as well as diameter of the tree trunk and/or the desired purpose of the device.

In certain additional aspects, above mentioned features (i)-(iii) of the frustoconical body are unitary and/or monobloc. In certain aspects, above-mentioned features (i)-(iv) of the frustoconical body are unitary and/or monobloc. In each of these aspects, the device is injection molded from, for example, moldable and/or thermoplastic resin including but not limited to a polyolefin, a polyurethane, or a polystyrene.

In certain aspects, the overall construction of the device (100) is sufficiently rigid and/or semi-rigid to provide support and protect the tree base and/or tree trunk as disclosed herein while in use, but is sufficiently pliable and resilient to handle and operable the device such that trees having varied trunk diameters may be received therein; this may be achieved by varying polymeric content and Shore A hardness when producing the device (100) and/or the hollow frustoconical body (102) of the device.

In certain aspects, also disclosed is a kit having the tree cultivation device packaged therein.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A tree cultivation device for water conservation and/or protection comprising:
(a) a hollow frustoconical body configured for receiving and enclosing a tree base therein; the hollow frustoconical body comprising:
(i) a base of the device configured for positioning on a ground or potting surface around and adjacent to a tree base in which a tree is planted, the base comprising an anchoring means attached to the base of the device that is configured to anchor the device into the ground or potting surface while the tree base is received and/or enclosed in the device;
(ii) a top end of the device with an opening defined by peripheral edges formed in the top end, the opening configured to receive a portion of a tree trunk therethrough and the peripheral edges defining the opening that are configured to directly contact and support the tree trunk;
(iii) a plurality of troughs formed within an outer surface of the hollow frustoconical body that are positioned between the base and top end of the device, each trough is spaced apart from one another and each trough is configured to dispense a liquid from an outer surface of the device internally within the device; and
(iv) a slit that continuously extends on the hollow frustoconical body from the peripheral edges defining the top end of the device to the base, such that the slit is openable and closable such that a tree base may be received internally within the hollow frustoconical body when the device is in use.

2. The tree cultivation device of claim 1, wherein the device comprises a concentric ring configuration when viewed from a top and/or bottom view.

3. The tree cultivation device of claim 2, wherein the device comprises a stepped configuration when viewed from a side view.

4. The tree cultivation device of claim 3, wherein features (i)-(iii) of the frustoconical body are unitary and/or monobloc.

5. The tree cultivation device of claim 4, wherein features (i)-(iv) of the frustoconical body are unitary and/or monobloc.

6. The tree cultivation device of claim 4, wherein the top end of the device comprises a planar surface radially extending inwardly from an outermost edge of the top end towards a center of the top end in which the peripheral edges of the opening are positioned.

7. The tree cultivation device of claim 6, wherein the top end further comprises a predetermined shape immediately adjacent to the peripheral edges of the opening the top end and extending in a direction away from the planar surface of the top end, the predetermined shape and peripheral edges are resiliently deformable to receive and support the tree trunk therein when the device is in use.

8. The tree cultivation device of claim 7, wherein the predetermined shape is a triangular shape when viewed from a top and/or bottom view.

9. The tree cultivation device of claim 8, wherein the base is annular shaped.

10. The tree cultivation device of claim 9, wherein the anchoring means are directly attached to the base.

11. The tree cultivation device of claim 10, wherein the anchoring means comprise a plurality of projections directly connected to and circumferentially positioned around the base with each projection extending in a direction away from the top end and base of the device.

12. The tree cultivation device of claim 11, wherein each projection of the plurality of projections of the anchoring means terminates in a sharp end configured to penetrate the ground or potting surface around and adjacent to the tree base to anchor the device when the device is in use.

13. The tree cultivation device of claim 12, wherein each trough has a curved shape configured to capture liquid emitted from an external source and pass the captured liquid to an interior of the device.

14. The tree cultivation device of claim 13, wherein the curved shape is a concavity extending in a direction from an outer surface towards the interior of the device when viewed from a top view of the device.

15. The tree cultivation device of claim 14, wherein each trough has an opening positioned therein that is in fluid communication with the interior of the device such that liquid captured from an exterior of the device on the trough is passed into the interior of the device via the opening positioned in each trough.

16. The tree cultivation device of claim 15, wherein in the opening in each trough has a parallel axial alignment relative to the opening in the top end.

17. The tree cultivation device of claim 16, wherein each trough is a circular shape formed on an outer diameter of the device when viewed from a top view of the device.

18. The tree cultivation device of claim 17, wherein each trough has a plurality of openings positioned therein, each opening of the plurality of openings is in fluid communication with the interior of the device such that liquid captured in each trough is passed from the exterior of the device on the trough to the interior of the device via each opening positioned in each trough.

19. The tree cultivation device of claim 18, wherein each opening of the plurality of openings in each trough has a parallel axial alignment relative to the opening in the top end.

20. The tree cultivation device of claim 19, wherein the device comprises a first and second trough with the first trough being more proximate to the top end of the device than the second trough, and the second trough being more proximate to the base of the device than the first trough.

21. The tree cultivation device of claim 20, wherein an outer diameter of the second trough is greater than an outer diameter of the first trough.
